(19) United States
(12) Patent Application Publication
(10) Pub. No.: US 2012/0165100 A1
(43) Pub. Date: Jun. 28, 2012

(54) CROWD MOBILE SYNCHRONIZATION

(75) Inventors: Richard Lalancette, Ottawa (CA); Stephen Nelson West, Ottawa (CA)

(73) Assignee: ALCATEL-LUCENT CANADA INC., Ottawa (CA)

(21) Appl. No.: 12/977,926

(22) Filed: Dec. 23, 2010

(51) Int. Cl. G06F 15/16; A63F 9/24

(52) U.S. Cl. 463/42; 709/248

(57) ABSTRACT

The invention is directed to a system and method for providing a synchronized game display to a plurality of mobile communications devices which can be grouped according to one or more attributes. Game display messages are specific to each grouping and comprise dance moves, song lyrics or other instructions to users of the mobile communication devices. A synchronization mechanism is provided to synchronize the displays the groups of mobile devices.

### FIELD OF THE INVENTION

The invention is directed to mobile communications and in particularly to a system and method for synchronized communications to multiple groups of mobile devices.

### BACKGROUND OF THE INVENTION

Systems have been developed to provide interactive experiences for spectators at sports and entertainment venues such as stadiums and arenas for sports such as football, baseball, soccer, hockey, and basketball. These systems typically use one or more large score boards or video screens present in sports venues to display dance moves or video game displays. Crowd Wave™ by Bent 360 of Ottawa, Canada, is one example of such interactive gaming systems. In the case where only one score board is present, such as in baseball venues, the entire audience follows the same display. Some venues where spectators surround the playing field, such as for basketball and hockey, have a centralized scoreboard with for example, four separate screens facing different directions, in which case four different displays could be provided to different parts of the spectator audience. The number of displays provided in these venues can limit the granularity of grouping of audience members for interactive synchronized sequential games where different groupings of audience members perform different dance moves in sequence.

Therefore, a means of providing a plurality of synchronized, coordinated displays to different groupings of audience members at a sports or entertainment venue would be highly desirable.

### SUMMARY OF THE INVENTION

One aspect of an embodiment of the present invention provides a method of providing a synchronized game display to a plurality of mobile communications devices. The method comprising steps of: receiving at a synchronization server, a registration message from each of the plurality of mobile communications devices; recording at the synchronization server, one or more attributes for each of the plurality of mobile communications devices; calculating at the synchronization server, a time offset for each of the plurality of mobile communications devices; and transmitting from the synchronization server, a game display message to each of the mobile communications devices, wherein the game display message comprises the respective time offset for each of the plurality of mobile communications devices.

In some embodiments of the present invention, the game display message further comprises a start time.

In some embodiments of the present invention, the step of calculating a time offset comprises receiving a local time from the mobile communication device and comparing the local time to a clock at the synchronization server.

In some embodiments of the present invention, the game display message comprises a sequence of dance moves.

In some embodiments of the present invention, the sequence of dance moves comprises an animation of the dance moves.

In some embodiments of the present invention, the game display message comprises song lyrics.

In some embodiments of the present invention, the song lyrics are animated.

Some embodiments of the present invention the further comprise steps of: assigning each of the plurality of mobile communications devices to one of a plurality of groups based on one or more of the attributes; and wherein the step of transmitting, comprises transmitting to each mobile communication device, a game display message specific to the respective group to which each mobile communication device is assigned.

In some embodiments of the present invention, the receiving and transmitting steps comprise receiving and transmitting via a third generation (3G) mobile cellular wireless service.

In some embodiments of the present invention, the receiving and transmitting steps comprise receiving and transmitting via a LTE (Long Term Evolution) or 4G (Fourth Generation) mobile cellular wireless service.

In some embodiments of the present invention, the receiving and transmitting steps comprise receiving and transmitting via a wireless local area network (WLAN).

In some embodiments of the present invention, the transmitting step comprises transmitting via a broadcast message.

Another aspect of an embodiment of the present invention provides a program storage device readable by a machine, tangibly embodying a program of instructions executable by the machine to perform the method steps described above.

Another aspect of an embodiment of the present invention provides a system for providing a synchronized game display to a plurality of mobile communications devices. The system comprises: a synchronization server capable of communication with the plurality of mobile communication devices; a game moves data base in communication with the synchronization server; and a game master console in communication with the synchronization server for controlling the synchronization sever, wherein the synchronization server is configured: to receive a registration message from each of the plurality of mobile communications devices; to record one or more attributes for each of the plurality of mobile communications devices; to calculate a time offset for each of the plurality of mobile communications devices; and to transmit a game display message to each of the mobile communications devices, wherein the game display message comprises the respective time offset for each of the plurality of mobile communications devices.

In some embodiments of the present invention, the synchronization server is further configured: to assign each of the plurality of mobile communications devices to one of a plurality of groups based on one or more of the attributes; and to transmit to each mobile communication device, a game display message specific to the respective group to which each mobile communication device is assigned.

In some embodiments of the present invention, the synchronization server is configured to receive and transmit via a third generation (3G) mobile cellular wireless service.

In some embodiments of the present invention, the synchronization server is configured to receive and transmit via a LTE (Long Term Evolution) or 4G (Fourth Generation) mobile cellular wireless service.

In some embodiments of the present invention, the synchronization server is configured to receive and transmit via a wireless local area network (WLAN).

### BRIEF DESCRIPTION OF THE DRAWINGS

Some embodiments of apparatus and/or methods in accordance with embodiments of the present invention are now described, by way of example only, and with reference to the accompanying drawings in which:

FIG. 1 illustrates a conceptual block diagram of an embodiment of the crowd mobile synchronization system of the present invention;

FIG. 2 illustrates a method of registering mobile users according to an aspect of an embodiment of the present invention; and

FIG. 3 illustrates a method of initiating a synchronized game according to an aspect of an embodiment of the present invention.

In the figures; like features are denoted by like reference characters.

### DETAILED DESCRIPTION

In general terms, aspects of the present invention provide a system and method for providing a plurality of groupings of synchronized displays in a public venue such as for example, a sports or entertainment stadium or arena, using mobile communication devices. Thus instead of using a single large video display or only four large video displays for all users, the system can display interactive game information on the screens of mobile telephones of individual users. This system can be used to coordinate or synchronize crowd body motion, crowd song lyrics, in a public venue via an application on a mobile communication device such as a mobile telephone.

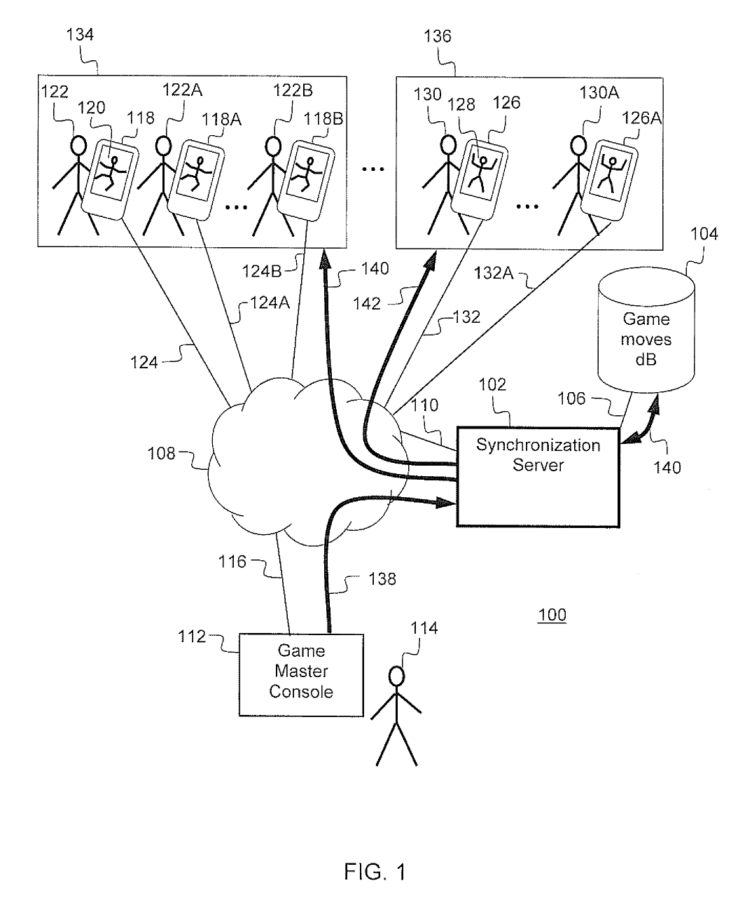

Referring to FIG. 1, a crowd mobile synchronization system 100 has a synchronization server 102 in communication with a game moves database 104 via link 106. The crowd mobile synchronization system 100 is typically located in an arena or stadium for the purpose of providing an interactive experience for the audience. The synchronization server 102 is in communication with network cloud 108 via link 110. Network cloud 108 is a generalized representation of a telecommunications network and may include the Internet and wireless communications systems including for example 3G and 4G systems. A game master console 112 under control of game master 114 is in communication with synchronization server 102 via communication link 116 and network cloud 108. The game master console 112 is typically a personal computer but could also be a laptop computer or a more portable device such as a mobile telephone having a graphical display and user interface. The game master 114 can initiate games and activities to engage the audience members and enhance their experience. Audience members (mobile users) 122, 122A, 122B, 130, 130A who have compatible mobile communication devices such as for example mobile device/smartphone 118, 118A, 118B, 126, 126A can establish communication with synchronization server 102 via wireless communication links 124, 124A, 124B, 132, 132A. In a typical scenario, when mobile users 122, 122A, 122B, 130, 130A arrive at the sports or entertainment venue they are advised via posters or signs at the venue, or by advance advertising, or by information provided on their tickets, that an interactive game experience is available. In one scenario communication is established by launching a software application (app) on their mobile device 118, 118A, 118B, 126, 126A when they arrive at the venue. The application can be downloaded and installed at the venue or in advance, via the mobile users' wireless data service. Thus when mobile users arrive at the venue, they can launch the mobile application which establishes communication with synchronization server 102 and registers the user's mobile device and conveys relevant information such as a user identifier (ID) which could be a mobile telephone number, an Internet protocol (IP) address, the local time of the user's mobile device for synchronization purposes, the user's seat number and or section number, and possibly the user's team affiliation and/or other attributes.

The mobile users 122, 122A, 122B, 130, 130A can be grouped based on user attributes, such as for example, their location, or their team affiliation. Users' locations can be identified by their seat number; by their section number; or their location coordinates could be identified by GPS (Global Positioning System) capabilities of their mobile device. The synchronization server 102 can calculate location or other groupings based on a mobile users' attributes, thus if a mobile user provides an attribute such as a seat number, or GPS location coordinates, the synchronization server 102 can calculate a section number or other appropriate grouping.

When an interactive game is initiated, the game master 114 can select the type of grouping suitable for the interactive game. In FIG. 1, mobile users 122, 122A, 122B are grouped in group 134, and mobile users 130, 130A are grouped in group 136. If a synchronized or sequential crowd dance game is initiated, different groups of users can have different dance moves displayed on their mobile device screens. Thus mobile users 122, 122A, 122B in group 134 would have a first dance move 120 displayed on their respective mobile devices 118, 118A, 118B and mobile users 130, 130A in group 136 would have a second dance move 128 displayed on their respective mobile devices 126, 126A. The dance moves could be displayed as a series of images (for example the current dance move and next dance move that that will need to be performed) or as an animation. These instructions would be timed and each section of the stadium or arena could have different move, thereby creating multiple synchronized dance moves across the venue. In this manner a metachronal wave (“the wave”) can be created, thus engaging individual participants in part of a larger experience. The mobile devices with accelerometers can be used to determine if the user performs the right move at the right time. This feedback information would be transmitted from those mobile devices to the synchronization server 102 which would store the feedback information associated for each mobile device in database 104. The game master 114 can access the feedback information per user or statistically per group to see which participants perform best. Based on performance, prizes could be given to the participants.

Other types of games would include karaoke or sing-along activities. For these games, song lyrics are displayed on the mobile device screens in a synchronized manner, with dynamic highlighting or a moving pointer to indicate which words of the song are to be sung at the moment. Thus different lyrics, or the same lyrics but with different timing could be transmitted to mobile users in different sections as a musical round, so that members of different groups sing the same melody but starting at different times, producing pleasing harmonies and musical effects.

Embodiments of the present invention make use of cellular mobile telephones and especially smart phones which typically provide more graphics, computing and human interface capabilities than other mobile devices. Numerous smartphones contain accelerometers, GPS receivers, cameras and other sensors which can be used to provide feedback to the synchronization server. Thus embodiments of the present invention are configured to receive and transmit via a third generation (3G) mobile cellular wireless service or LTE (Long Term Evolution) or 4G (Fourth Generation) mobile cellular wireless service. Femto cells or other technology to add more lower power wireless telecommunication cells can aid in haling a high concentration of active mobile telecommunications devices and can aid in providing location information to the mobile devices with finer granularity than standard cell tower triangulation techniques. Other embodiments are configured to receive and transmit via wireless local area network (WLAN) (“Wi-Fi”) especially in smaller or enclosed environments.

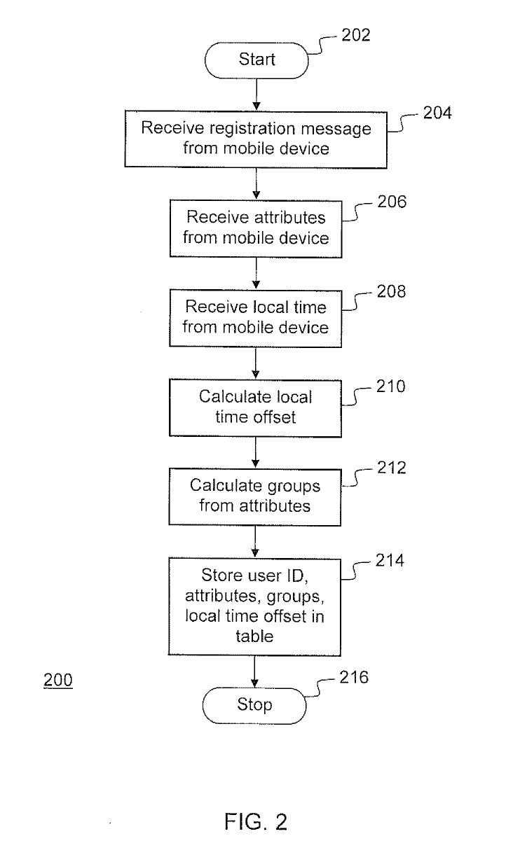

With reference to FIG. 2, a registration process 200 runs on synchronization server 102, for each mobile user. The process starts at step 202. When a mobile user enters a venue and launches the mobile application, the mobile device sends a registration message which is received by synchronization server 102 at step 204. At step 206, the synchronization server 102 receives attributes from the mobile device, such as location coordinates or seat number or seat section number and/or team affiliation or other attribute. These attributes could be entered manually by the mobile user or could be determined automatically in several different ways such as: using an on-board GPS receiver to determine location coordinates, which is typically most effective in outdoor venues; using an on-board camera on the mobile device to photograph the user's admission ticket and analyze the resulting image to extract the seat number using character recognition or by reading a bar code printed on the admission ticket. At step 208, the synchronization server 102 receives a local time from the on-board clock on the mobile device. At step 210 synchronization server 102 calculates a local time offset by comparing the received local time of the mobile device from step 208 with the internal clock of the synchronization server 102. At step 212, the synchronization server 102 calculates groups from the attributes from step 206. Thus if the seat section number is intended to be used as a group but the attributes received at step 206 include a seat number but not a section number, then a section number is calculated from the seat number. Likewise, if location coordinates are received but a section number is required, then the location coordinates are mapped to a section number. If a team affiliation is intended to be used as a grouping, or if a combination of attributes are intended to be used to determine groupings then these groups are calculated (for example even numbered seats on the west side of the venue or arena; or fans of the home team on the north side of the arena).

At step 214, synchronization server 102 stores the data related to the mobile device (user ID, attributes, local time offset, calculated groups, etc) in a user table in database 104. Such a user table is illustrated in Table 1 below. The registration process stops at step 216. The registration process is executed for each mobile user who activates the application on his mobile device upon entering the arena or venue. Thus the user table in database 104 is updated for each mobile user participating in the crowd participation games. When crowd games are initiated by games are initiated by game master 114, the current data from the database 104 is used.

TABLE 1

| User ID | IP address | Time offset | GPS coord. | Seat # | Section # |
|---|---|---|---|---|---|
| 514-555- | | −0.005 | | E84 | 201 |
| 5555 | | | | | |
| 613-555- | | +0.133 | | E85 | 201 |
| 4444 | | | | | |
| 613-555- | | +2.357 | 45.347063, | | 305 |
| 6666 | | | −75.921299 | | |

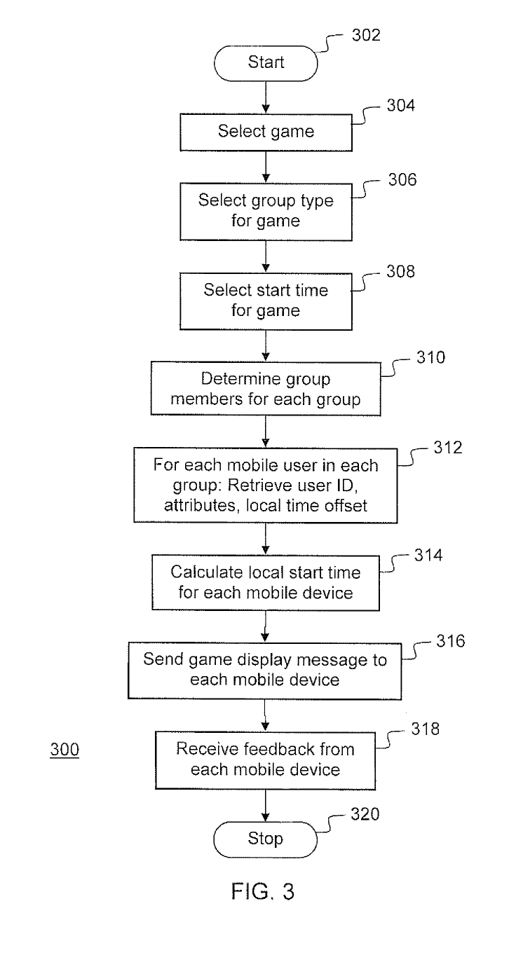

With reference to FIG. 3, a game process 300 runs on synchronization server 102. The process starts at step 302. At step 304, the synchronization server 102 receives a command from the game master 114 through the game master console 112 to select a specific game from among a plurality of games stored in game moves database 104. At step 306 a group type is selected, such as seat section of mobile users, team affiliation of mobile users or other grouping criteria or combination of grouping criteria. At step 308 a start time for the game or game segment is selected. This is typically a couple of minutes ahead of the current time. At step 310 the process determines the group members for each group. If the group type is for example, seat section number then this is merely read from the appropriate column of the user table (Table 1). If the group type is a combination of grouping criteria, then this is calculated from the attributes for each user in the user table (Table 1). At step 312 the process retrieves for each mobile device in each group, the mobile device's user ID, the attributes and the local time offset. At step 314 the local start time is calculated for each mobile device, based on the selected start time of step 308 and the local time offset from the user table (Table 1). At step 316 the game or game segment is transmitted to each mobile device as a game display message. This includes the aspects of the game to be displayed on the mobile devices as well as the local start time relative to the local clock on the mobile device. The aspects of the game to be displayed include a video clip or an animation sequence of dance moves to be performed by the users or an animation of song lyrics to be sung by participants. By determining the time offset in advance, and compensating for the time offset of each mobile device, all the games being displayed on the participating mobile devices are effectively synchronized in time, thereby permitting synchronized and coordinated game activity for all participants. This also compensates for the finite time required to transmit the game display messages to a large number of mobile devices, which could easily number 50,000 or more devices at large sports venues. At step 318 feedback information is received from the mobile devices is associated with each mobile device and stored in the in database 104. In one embodiment, the feedback information is stored in a column added to the user table (Table 1), stored in database 104.

During the course of the spectator event, before the main event and during intermissions, various games can be initiated by game master 114, to encourage spectators (mobile users) to participate in a collective event which can help foster a sense of community or just convey a sense of participation. This is a differentiator compared to viewing the event remotely via broadcast television for example. The process stops at step 320.

A person of skill in the art would readily recognize that steps of various above-described methods can be performed by programmed computers. Herein, some embodiments are also intended to cover program storage devices, e.g., digital data storage media, which are machine or computer-readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Numerous modifications, variations and adaptations may be made to the embodiment of the invention described above without departing from the scope of the invention, which is defined in the claims.

What is claimed is:

1. A method of providing a synchronized game display to a plurality of mobile communications devices, the method comprising steps of:
receiving at a synchronization server, a registration message from each of said plurality of mobile communications devices;
recording at said synchronization server, one or more attributes for each of said plurality of mobile communications devices;
calculating at said synchronization server, a time offset for each of said plurality of mobile communications devices; and
transmitting from said synchronization server, a game display message to each of said mobile communications devices,
wherein said game display message comprises said respective time offset for each of said plurality of mobile communications devices.

2. The method of claim 1, wherein said game display message further comprises a start time.

3. The method of claim 1, wherein said step of calculating a time offset comprises receiving a local time from said mobile communication device and comparing said local time to a clock at said synchronization server.

4. The method of claim 1, wherein said game display message comprises a sequence of dance moves.

5. The method of claim 4, wherein said sequence of dance moves comprises an animation of said dance moves.

6. The method of claim 1, wherein said game display message comprises song lyrics.

5. The method of claim 6, wherein said song lyrics are animated.

7. The method of claim 1, further comprising steps of:
assigning each of said plurality of mobile communications devices to one of a plurality of groups based on one or more of said attributes; and
wherein said step of transmitting, comprises transmitting to each mobile communication device, a game display message specific to the respective group to which each mobile communication device is assigned.

8. The method of claim 1, wherein said receiving and transmitting steps comprise receiving and transmitting via a third generation (3G) mobile cellular wireless service.

9. The method of claim 1, wherein said receiving and transmitting steps comprise receiving and transmitting via a LTE (Long Term Evolution) or 4G (Fourth Generation) mobile cellular wireless service.

10. The method of claim 1, wherein said receiving and transmitting steps comprise receiving and transmitting via a wireless local area network (WLAN).

11. The method of claim 1, wherein said transmitting step comprises transmitting via a broadcast message.

12. A program storage device readable by a machine, tangibly embodying a program of instructions executable by the machine to perform the method steps of claim 1.

13. A system for providing a synchronized game display to a plurality of mobile communications devices, the system comprising:
a synchronization server capable of communication with said plurality of mobile communication devices;
a game moves data base in communication with said synchronization server; and
a game master console in communication with said synchronization server for controlling said synchronization sever,
wherein said synchronization server is configured:
to receive a registration message from each of said plurality of mobile communications devices;
to record one or more attributes for each of said plurality of mobile communications devices;
to calculate a time offset for each of said plurality of mobile communications devices; and
to transmit a game display message to each of said mobile communications devices,
wherein said game display message comprises said respective time offset for each of said plurality of mobile communications devices.

14. The system of claim 13, wherein said synchronization server is further configured:
to assign each of said plurality of mobile communications devices to one of a plurality of groups based on one or more of said attributes; and
to transmit to each mobile communication device, a game display message specific to the respective group to which each mobile communication device is assigned.

15. The system of claim 14, wherein said synchronization server is configured to receive and transmit via a third generation (3G) mobile cellular wireless service.

16. The system of claim 14, wherein said synchronization server is configured to receive and transmit via a LTE (Long Term Evolution) or 4G (Fourth Generation) mobile cellular wireless service.

17. The method of claim 14, wherein said synchronization server is configured to receive and transmit via a wireless local area network (WLAN).
